(19) United States
(12) Patent Application Publication
(10) Pub. No.: US 2025/0026386 A1
(43) Pub. Date: Jan. 23, 2025

(54) SYSTEM AND METHOD FOR DIAGNOSING OPERATIONAL SAFETY OF RAILCARS

(71) Applicant: KOREA RAILROAD RESEARCH INSTITUTE, Uiwang-si (KR)

(72) Inventors: Hyun Moo HUR, Uiwang-si (KR); Kyung Ho MOON, Seoul (KR); Seong Kwang HONG, Suwon-si (KR); Young Sam HAM, Uiwang-si (KR)

(21) Appl. No.: 18/776,296

(22) Filed: Jul. 18, 2024

(30) Foreign Application Priority Data
Jul. 20, 2023 (KR) 10-2023-0094393

(51) Int. Cl. B61L 15/00; G01H 17/00

(52) U.S. Cl. CPC B61L 15/0081; B61L 15/0072; G01H 17/00

(57) ABSTRACT

Provided are a system and method for diagnosing operational safety of railcars in which one or more vibration sensors installed in each car of a train measure and analyze vibrations generated from the running car, running information including the travel location and travel speed of the car is added to vibration data and transmitted to a central control system, integrated running information is analyzed through pretrained artificial intelligence (AI) to estimate an abnormal part of the cars or railroad, and the AI is retrained through big data analysis.

### CROSS-REFERENCE TO RELATED APPLICATION

This application claims priority to and the benefit of Korean Patent Application No. 10-2023-0094393, filed on Jul. 20, 2023, the disclosure of which is incorporated herein by reference in its entirety.

### BACKGROUND

### 1. Field of the Invention

The present invention relates to a diagnostic system for real-time diagnosis of abnormalities which affect travel safety, such as derailment of a railcar, and more particularly, to a system and method for diagnosing operational safety of railcars in which one or more vibration sensors installed in each car of a train measure and analyze vibrations generated from the running car, running information including the travel location and travel speed of the car is added to vibration data and transmitted to a central control system, integrated running information is analyzed through pretrained artificial intelligence (AI) to estimate an abnormal part of the cars or the track, and the AI is retrained through big data analysis.

### 2. Discussion of Related Art

A railroad is a tracked facility for the rapid transportation of passengers or goods in large quantities via railcars. A pair of rails, which are laid parallel to the ground, guide the travel direction of wheels oppositely positioned along each side of a railcar, allowing the railcar to travel in a straight or curved line.

The rolling motion of the wheels on the rails is caused by the frictional force generated when the wheels connected to a power source of the railcar contact the rails, causing the railcar to travel along the rails. To prevent the wheels from deviating from the rails while the railcar is running, the inner wheel treads of both wheels in contact with the rails protrude outward along the wheel radius to form a flange.

During the running of a railcar, movement of wheels along the upper surfaces of the rails causes the railcar to move, and lateral movement relative to the travel direction is controlled by the flange. Accordingly, there is always a risk of safety incidents caused by derailment of railcars, and to prevent derailment accidents due to abnormalities in railcars, a diagnostic system for monitoring the states of railcars in real time ensures the safe travel of railcars.

Vehicle diagnostic systems for diagnosing abnormalities during the travel of railcars usually follow a condition-based maintenance (CBM) scheme. According to CBM, a sensor or diagnostic device is installed at a key portion that affects the travel safety of railcars, and a detection signal which is generated by detecting an abnormality through the sensor or diagnostic device during the travel of the railcars is transmitted to an engineer or vehicle control system to take an emergency measure such as slowing down or emergency stopping.

As an example of such a railcar diagnostic system, Korean Patent Publication No. 10-2235625 (registered on Mar. 29, 2021) discloses a system for diagnosing an abnormal state of a railcar that excites rails through a vibration exciter to generate a sine wave in the rails at certain time intervals, measures vibrations of a railcar caused by the excitation through a measurement part, and diagnoses an abnormal state of the railcar on the basis of the measured vibrations.

Due to the feature of a train including multiple connected cars, derailment may result in a large number of casualties, and thus it is necessary to continuously monitor abnormal states of railcars during operation. However, such a railcar diagnostic system cannot diagnose an abnormal state of a railcar in sections other than a diagnosis section.

Also, even if railcars are kept in a good state, derailment may also occur when there is a problem with rails. With existing railcar diagnostic systems for checking an abnormal state of railcars by analyzing a vibration pattern measured through a vibration sensor, it is not possible to detect an abnormality with rails.

### RELATED ART DOCUMENTS

### Patent Documents

(Patent Document 1) Korean Patent Publication No. 10-2235625 (Mar. 29, 2021)

### SUMMARY OF THE INVENTION

The present invention is directed to providing a system and method for diagnosing operational safety of railcars in which abnormal states of a railcar and a track are separately detected in real time, and when an abnormal state is detected, an emergency measure, such as slowing down or emergency stopping, is taken on a train including a corresponding railcar or running on a corresponding track, and a check and maintenance are performed on a part diagnosed with the abnormal state.

According to an aspect of the present invention, there is provided a system for diagnosing operational safety of railcars, the system including a vibration diagnosis module configured to acquire a vibration signal by measuring vibrations generated from a running car through one or more vibration sensors installed in each car of a train and generate vibration data by analyzing the vibration signal, a car computer installed in each car and configured to receive the vibration data generated by the vibration diagnosis module of the corresponding car and then generate running data by adding running information including a travel location and a travel speed of the car to the vibration data, a train control and monitoring system (TCMS) configured to generate integrated running data by aggregating the running data received from the car computers of the cars constituting the train and then transmit the integrated running data to a central control system, a server configured to build big data by storing the integrated running data transmitted to the central control system, and a big data analysis module configured to estimate an abnormal part of a car or a track by analyzing the integrated running data through pretrained artificial intelligence (AI) and transmit the estimated abnormal part to the central control system so that the AI is retrained using data which is acquired by comparing an estimation result with an actual measurement result of an abnormality check. The entire track on which the train runs is divided into a certain number of sections, and the vibration data measured from the car is generated section by section so that the big data analysis module estimates an abnormal part of a specific car or the track.

The vibration diagnosis module may generate the vibration data using an analysis method based on any one of a root mean square (RMS), a vibration level, a ride comfort index, and a ride comfort level which are representative values of a dynamic state of the car.

The vibration sensors of the vibration diagnosis module may be installed on a main part of the car including a wheelset or a bogie.

The vibration diagnosis module may determine whether the measured vibration data falls within a preset vibration value tolerance range for a corresponding track section, transmit a determination result to the car computer along with the vibration data, and feed an AI retraining result based on big data analysis by the big data analysis module back to continuously update the preset vibration value tolerance range.

The preset vibration value tolerance range may be set depending on types including a vehicle type of the train or the cars, a format of the train or the cars, or the number of organized cars, and the integrated running data transmitted from the TCMS to the central control system may include type-specific data including the vehicle type of the train or the cars, the format of the train or the cars, or the number of organized cars.

The big data analysis module may build an abnormality diagnosis map of the track and the cars by diagnosing a specific track section as a dangerous section when abnormal vibration data is measured from a plurality of trains running on the track section, or diagnosing a specific car with an abnormality when abnormal vibration data is measured from the car running on all track sections, and estimate an abnormal part of the track or the car.

The big data analysis module may retrain the AI in order of an operation of selecting integrated running data stored in the server, an operation of preprocessing the selected data, an operation of converting the preprocessed data, a data mining operation, and a pattern analysis operation.

The pattern analysis operation may be performed using any one selected from among linear regression, an artificial neural network, K-nearest neighbor, and unsupervised learning.

According to another aspect of the present invention, there is provided a method of diagnosing operational safety of railcars, the method including a vibration data generation operation in which a vibration diagnosis module receiving a measurement signal from one or more vibration sensors installed in each car of a train acquires a vibration signal by measuring vibrations generated from the running car and generates vibration data by analyzing the vibration signal, a running data generation operation in which a car computer installed in the car receives the vibration data generated by the vibration diagnosis module of the car and generates running data by adding running information including a travel location and a travel speed of the car to the vibration data, an integrated running data generation operation in which a TCMS generates integrated running data by aggregating the running data received from the car computers of the cars constituting the train and then transmits the integrated running data to a central control system, an abnormality estimation operation of storing the integrated running data transmitted to the central control system in a server, analyzing the transmitted integrated running data through pretrained AI included in a big data analysis module, wherein the analyzing of the integrated running data includes dividing an entire track on which the train runs into a certain number of sections, separately generating vibration data measured from the car section by section, diagnosing a specific track section as a dangerous section when abnormal vibration data is measured from a plurality of trains running on the track section, or diagnosing a specific car with an abnormality when abnormal vibration data is measured from the car running on all track sections, and providing a track or car abnormality estimation result to the central control system, an abnormality handling operation in which the central control system takes measures against an abnormal situation when a track or car abnormality is estimated, and a retraining operation of comparing the estimation result with an actual measurement result of an abnormality check to retrain the AI.

The vibration data generation operation may include determining, by the vibration diagnosis module, whether the generated vibration data falls within a preset vibration value tolerance range for a corresponding track section and transmitting a determination result to the car computer along with the vibration data, and the retraining operation may include feeding an AI retraining result based on big data analysis by the big data analysis module back to the vibration diagnosis module to continuously update the preset vibration value tolerance range.

The retraining operation may include retraining, by the big data analysis module, the AI in order of an operation of selecting integrated running data stored in the server, an operation of preprocessing the selected data, an operation of converting the preprocessed data, a data mining operation, and a pattern analysis operation, and the pattern analysis operation may be performed using any one selected from among linear regression, an artificial neural network, K-nearest neighbor, and unsupervised learning.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an overall structure of a system for diagnosing operational safety of railcars according to the present invention;

FIG. 2 is a diagram illustrating a data aggregation operation in a process in which the system for diagnosing operational safety of railcars according to the present invention generates integrated running data from vibration signals measured by vibration sensors installed in cars;

FIG. 3 is a diagram of track section units that are formed by the system for diagnosing operational safety of railcars according to the present invention through track division to distinguish between a track abnormality and a car abnormality and specify a track section with an abnormality when the track abnormality is detected;

FIG. 4A and FIG. 4B are a set of histograms showing an example of specifying a sectional location in a track where an abnormality is estimated by comparing vibration data measurement values measured by vibration sensors with a vibration value tolerance range according to the present invention;

FIG. 5 is a diagram showing an example in which the system for diagnosing operational safety of railcars according to the present invention specifies a track section with an abnormality using vibration data measured from a plurality of trains;

FIG. 6 is a diagram showing an example in which the system for diagnosing operational safety of railcars according to the present invention specifies a car with an abnormality using vibration data measured from a specific car of a running train; and

FIG. 7 is a flowchart illustrating a method of diagnosing operational safety of railcars according to the present invention.

### DETAILED DESCRIPTION OF EXEMPLARY EMBODIMENTS

Hereinafter, exemplary embodiments of the present invention will be described in detail with reference to the accompanying drawings.

The exemplary embodiments will be described in detail, focusing on parts necessary to understand operations and effects related to the present invention.

In describing the exemplary embodiments of the present invention, description of technology that is well known in the technical field to which the present invention pertains and is not directly related to the present invention will be omitted.

This is intended to clearly convey the subject matter of the present invention without obscuring it.

Also, in describing components of the present invention, different reference numerals may be given to components with the same name in different drawings, or the same reference numeral may be given in different drawings.

Even in this case, it does not mean that corresponding components have different functions in different embodiments or have the same function in different embodiments. Rather, a function of each component is determined on the basis of description of the component in a corresponding embodiment.

Unless particularly defined otherwise, technical terms used herein should be construed as generally understood by those of ordinary skill in the art to which the present invention pertains, and should not be construed as having an overly comprehensive meaning or overly reduced meaning.

As used herein, singular expressions include plural expressions unless the context indicates otherwise.

In this specification, the terms “comprise,” “comprising,” “include,” “including,” “have,” “having,” and the like should not be construed as necessarily including all components or operations described herein. Some components or operations may not be included, or additional components or operations may be further included.

In this specification, a bogie which is a travel system including wheelsets including wheels and axles, journal boxes, car suspensions, a towing apparatus, a braking apparatus, and a coupler, and a body in which passengers are carried or driving equipment is mounted are combined into a car 11. A train 10 is one set of railway vehicles that is organized by connecting multiple cars 11 in a row through couplers.

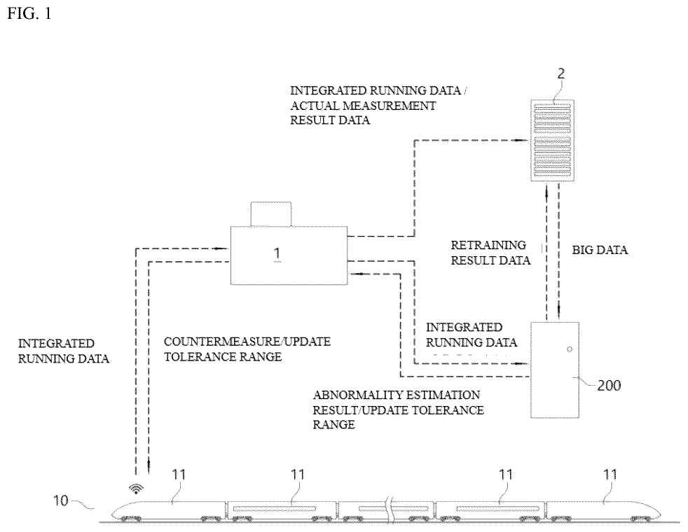

As shown in FIG. 1, a system for diagnosing operational safety of railcars according to the present invention generates running data from vibration signals acquired from the cars 11 constituting the train 10, transmits the running data to a central control system 1, analyzes the running data through a big data analysis module 200 to estimate an abnormal part of the cars 11 or a track, and generates big data by analyzing running data stored in a server 2, improving accuracy of estimation about an abnormality of the cars 11 or the track made by the system for diagnosing operational safety of railcars.

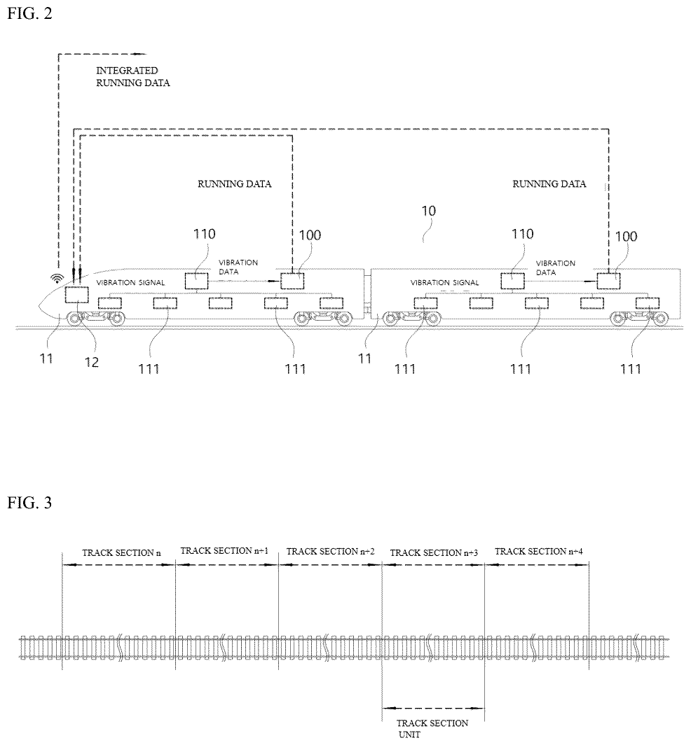

As shown in FIG. 2, one or more vibration sensors 111 are installed in each car 11 of the train 10 and measure vibrations transmitted from the track to the car 11 through wheels or generated from the car 11 to acquire vibration signals. The vibration signals acquired through the vibration sensors 101 are transmitted to a vibration diagnosis module 110 installed in the car 11, and the vibration diagnosis module 110 analyzes the measured vibration signals to generate vibration data.

The vibration sensors 111 are preferably installed on wheelsets, a bogie, and a body which are main parts of each car 111. However, the vibration sensors 111 may be only installed at a limited number of spots on the wheelsets or the bogie to reduce an increase in the cost of building the system for diagnosing operational safety of railcars due to installation of multiple vibration sensors 111, the load of vibration signal analysis and vibration data transmission at the vibration diagnosis module 110, or the capacity of big data which is running data stored in the server 2.

The generation of vibration data by the vibration diagnosis module 110 is performed by analyzing a representative value which may represent a dynamic state of the car 11. The representative value obtained from the vibration sensors 111 may include a root mean square (RMS) value, a vibration level, a ride comfort index, a ride comfort level, and the like, and vibration data is generated using an analysis method using any one selected from among these.

An RMS represents an effective power which is a base of the average power of vibration signals continuously output by the vibration sensors 111, and is calculated by taking the arithmetic mean of the squares of vibration signal output values and then taking the square root of the arithmetic mean value. As a vibration level, the intensity of a vibration signal measured by the vibration sensor 111 is converted to decibels (dB) in an absolute value.

After vibration acceleration signals caused by linear vibrations of the car 11 in the front and back directions, linear vibrations in the left and right directions, and linear vibrations in the up and down directions measured through the vibration sensors 111 are passed through a weighting filter, a cumulative frequency distribution is acquired by calculating an effective value at certain intervals, and a vibration acceleration corresponding to 95% of the cumulative frequency distribution is calculated and substituted into the following ride comfort index formula, which yields a ride comfort index.

$$Ride comfort index : N = 6 \sqrt{{( {a}_{XP 95} )}^{2} + {( {a}_{YP 95} )}^{2} + {( {a}_{ZP 95} )}^{2}}$$

Here, α_{XP95} is a vibration acceleration corresponding to 95% of the cumulative frequency distribution of front-to-back vibrations, α_{YP95} is a vibration acceleration corresponding to 95% of the cumulative frequency distribution of left-to-right vibrations, and α_{ZP95} is a vibration acceleration corresponding to 95% of the cumulative frequency distribution of top-to-bottom vibrations.

A ride comfort level is calculated by applying a ride comfort filter corresponding to human perception evaluation sensitivity to an effective value of a body vibration acceleration of the car 11 measured by the vibration sensors 111 on the basis of International Organization for Standardization (ISO) 2631 and is expressed in decibels. A ride comfort level is calculated according to the following ride comfort level formula.

$$Ride comfort level : {L}_{eq} = 20 log \frac{{a}_{w}}{{a}_{ref}}$$

Here, α_{ω} is an effective value of a vibration acceleration to which the ride comfort filter is applied, and α_{ref} is a reference value of vibrations to which the ride comfort filter is applied.

Also, the vibration diagnosis module 110 compares the vibration data generated as described above with a vibration value tolerance range which is preset therein and determines whether the vibration data is within or outside of the tolerance range.

Since the track is installed in various terrain environments, such as flat ground, a tunnel, a bridge, and the like, the vibration data acquired through the vibration diagnosis module 110 may vary with each section of the track. When the vibration value tolerance range is uniformly preset in the vibration diagnosis module 110, depending on a terrain environment in which the track is installed, vibration data acquired from the track or the car 11 in a normal state may be determined to correspond to an abnormal state, or vibration data acquired from the track or the car 11 in an abnormal state may be determined to correspond to a normal state.

Therefore, as shown in FIG. 3, the entire track on which the train 10 runs is divided into a certain number of sections according to terrain conditions or requirements for safe running management and maintenance to generate sectional units for each track. Accordingly, vibration signals measured through the vibration sensors 111 and vibration data acquired by the vibration diagnosis module 110 are generated per track section.

Also, the preset vibration value tolerance range in the vibration diagnosis module 110 is set per track section.

Along with a change in the type of car 11, vibration signals measured through the vibration sensors 111 and vibration data acquired by the vibration diagnosis module 110 change such as a change in the vibration pattern of the car 11 and the like caused by the type of car 11, that is, a locomotive, a carriage, or a freight car, a particular model of the train 10 or the form of car 11, the number of organized cars 11 or the way that the cars 11 are connected, or the application of diesel or electric power. Accordingly, the preset vibration value tolerance range in the vibration diagnosis module 110 is set separately for various types including the type of train 10 or cars 11, the format of the train 10 or the cars 11, or the number of organized cars 11.

Vibration data generated by a vibration diagnosis module 110 is transmitted to a car computer 100 installed in each car 11, and each car computer 100 receives vibration data generated by the vibration diagnosis module 110 of a corresponding car 11 and then generates running data by adding running information, which includes a travel location and a travel speed of the car 11 acquired from Global Positioning System (GPS) data received through a train control and monitoring system (TCMS) 12, to the vibration data.

The running information added to the running data makes it possible to specify the location of a track section from which the vibration data included in the running data is acquired, and rapidly take measures for checking or maintaining the track when the track is determined to correspond to an abnormal state.

Running data generated by each car computer 100 installed in each car 11 constituting the train 10 is transmitted to the TCMS 12, and the TCMS 12 generates integrated running data by aggregating the received running data and then transmits the integrated running data to the central control system 1.

Integrated running data transmitted from the TCMS 12 of each train 10 is transmitted to and stored in the server 2 connected to the central control system 1 through a network, and big data of the system for diagnosing operational safety of railcars is built from the integrated running data cumulatively stored in the server 2.

The big data analysis module 200 is connected to the central control system 1 and the server 2 through the network and receives integrated running data transmitted from the TCMS 12 of each train 10 in real time to analyze the integrated running data through pretrained artificial intelligence (AI).

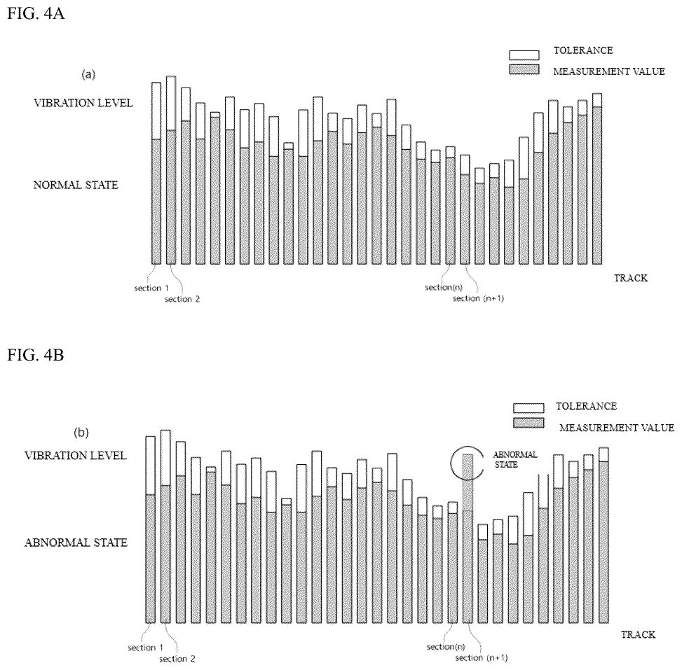

When an abnormality in a car 11 or the track is estimated because a vibration data measurement value is found to exceed the vibration value tolerance range as a result of analyzing integrated running data through the big data analysis module 200 as shown in FIG. 4, the car 11 of the train 10 or the location of a track section where the abnormality is estimated is specified, and the estimation result is transmitted to the central control system 1.

The central control system 1 receiving the estimation result takes an emergency measure, such as slowing down or emergency stopping, on a train 10 including the car 11 where an abnormality is estimated or a train 10 approaching the track section where an abnormality is estimated depending on the level of the estimation result.

In the case of slowing down, after the operating hours of the railroad are completed, personnel for check and repair work are sent to the track section or the car 11 where an abnormality is estimated. In the case of emergency stopping, personnel for check and repair work are immediately sent to the corresponding track section or the corresponding car 11.

In addition, the big data analysis module 200 acquires big data of the accuracy of abnormality estimation analysis by comparing results of estimating an abnormality in cars 11 or tracks with actual measurement results of abnormality checks which are results of taking emergency measures through the central control system 1, and the AI is retrained using the acquired data.

The vibration value tolerance range which is acquired as a result of AI retraining based on big data analysis by the big data analysis module 200 is fed back as a vibration value tolerance range which is set for the vibration diagnosis module 110 and the big data analysis module 200, to update the previously set vibration value tolerance range of the vibration diagnosis module 110 and the big data analysis module 200.

At certain intervals set by a manager of the system for diagnosing operational safety of railcars, the AI is periodically retrained through big data analysis on integrated running data which is cumulatively stored in the server 2, to continuously update the vibration value tolerance range. Accordingly, the accuracy of a result of estimating an abnormality in a car 11 or the track through the big data analysis module 200 can be improved.

Retraining of the AI through the big data analysis module 200 is performed in order of an operation of selecting integrated running data stored in the server 2, an operation of preprocessing the selected data, an operation of converting the preprocessed data, a data mining operation, and a pattern analysis operation.

The pattern analysis operation is performed using any one selected from among linear regression, an artificial neural network, K-nearest neighbor, and unsupervised learning.

Linear regression is an analysis technique for modeling a linear correlation (regression equation) between known data values, such as vibration data measured through the vibration sensors 111 or the integrated running data, using a technique such as a least square method or the like, and then estimating unknown data and parameters from the modeled linear correlation.

An artificial neural network is a machine learning model that mimics the structure of human neurons using software, and is repeatedly trained in a way that is expected to minimize errors with pretraining data. Accordingly, weights and thresholds are updated so that AI is implemented.

A K-nearest neighbor algorithm is an algorithm for classifying data with reference to the labels of other data which is close to the data using a Euclidean distance calculation method. According to the K-nearest neighbor algorithm, K pieces of data adjacent to data to be classified are searched for, and the data is classified into a category to which the majority of the data labels belong. Since the K-nearest neighbor algorithm is simple, a training operation is not time-consuming, and excellent performance is shown in value-based data classification tasks.

Since the K-nearest neighbor algorithm is a distance-based model, it is necessary to apply normalization, such as min-max normalization or z-score normalization, to readjust variable values to a standard range to facilitate the interpretation of the difference between variables, and it is preferable to set K to an odd number for classification of data.

Unsupervised learning is an analytical technique for analyzing unlabeled data sets and grouping data with the same or similar features into clusters using a machine learning algorithm which allows a system to learn and improve autonomously by providing a large amount of data without explicit programming.

Here, the vibration value tolerance range is set according various types including the vehicle type of the train 10 or the cars 11, such as Korea Train eXpress (KTX), Super Rapid Train (SRT), or sub-model classifications thereof, the format of the train 10 or the cars 11, such as power-concentrated KTX connection or power-distributed KTX connection, the number of organized cars 11, such as 10-car KTX or 20-car KTX, and the like. When an abnormality in the car 11 or the track is estimated by comparing the vibration data with the vibration value tolerance range through the vibration diagnosis module 110 or comparing the integrated running data with the vibration value tolerance range through the big data analysis module 200, the number of errors in estimating an abnormality in the car 11 or the track is minimized by applying the vibration value tolerance ranges which are set separately depending on type.

Unlike existing vehicle diagnostic systems to which a condition-based maintenance (CBM) method of checking states of major vehicle devices in real time using various sensors and collecting and analyzing failure history or maintenance data is applied, the system for diagnosing operational safety of railcars according to the present invention can not only diagnose an abnormality in the cars 11 but also estimate an abnormality in the track. A process of separately estimating an abnormality in the cars 11 and an abnormality in the track from vibration data measured through the same vibration sensor 111 is performed as follows.

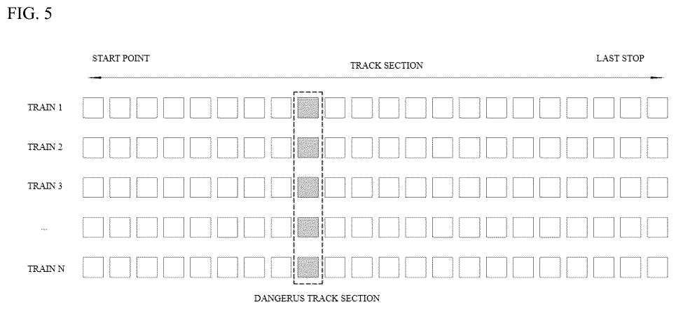

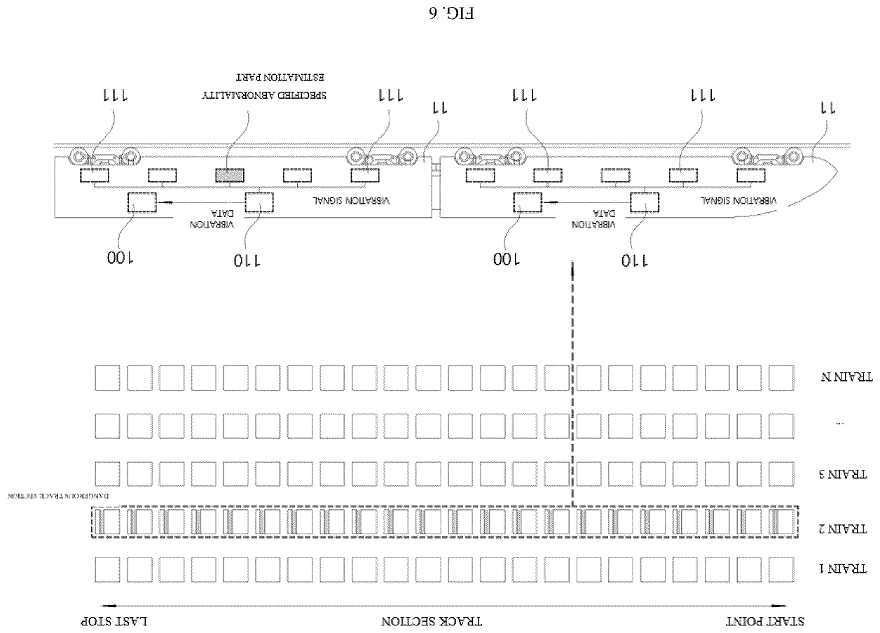

As shown in FIG. 5, when vibration data measured from a plurality of trains 10 which run on a specific track section exceeds the vibration value tolerance range based on the track section and the type of cars 11 of a corresponding train 10 and it is determined that abnormal vibration data is generated, the corresponding track section is diagnosed as a dangerous section. To prevent an error in determining a dangerous track section, whether there is an abnormality in the track is determined on the basis of vibration data measured from at least three trains 10.

As shown in FIG. 6, vibration data measured from a specific car 11 of a train 10 running on all the track sections periodically or intermittently exceeds the vibration value tolerance range based on a corresponding track section and the type of cars 11 of a corresponding train 10 in a plurality of track sections as abnormal vibration data. Here, when the same or similar pattern of vibration data is not acquired from cars 11 of other trains 10, the car 11 from which the abnormal vibration data is acquired is diagnosed with an abnormality.

To separately estimate abnormalities in the cars 11 and the track, the big data analysis module 200 builds an abnormality diagnosis map of the track and the cars 11 using the above determination method. On the basis of the abnormality diagnosis map, the big data analysis module 200 separately diagnoses abnormalities in the cars 11 and the track and accurately specifies a track section or a car 11 which is in an abnormal state.

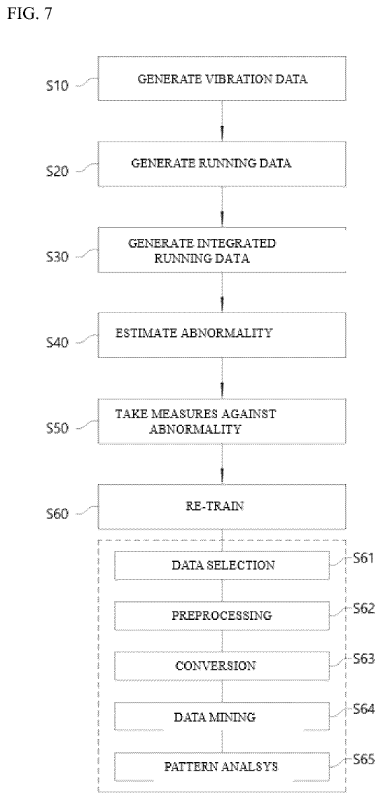

A method of for diagnosing operational safety of railcars using the foregoing system for diagnosing operational safety of railcars is performed as illustrated in FIG. 7.

In a vibration data generation operation S10, a vibration diagnosis module 110 receives measurement signals from vibration sensors 111 installed in each car 11 of a train 10 to acquire vibration signals generated from the running car 11, and vibration data is generated by analyzing the vibration signals through the vibration diagnosis module 110.

In a running data generation operation S20, the vibration data generated in the vibration data generation operation S10 is received by a car computer 100 installed in the same car 11 from which the vibration data is acquired, and when the vibration data is acquired, running data including a travel location that is the location of a track section on which the car 11 is running and a travel speed that is the speed at which the car 11 is running through the track section is added to the vibration data to generate running data.

In an integrated running data generation operation S30, running data received from car computers 100 of cars 11 constituting the train 10 in the running data generation operation S20 is aggregated through a TCMS 12 to generate integrated running data, and the TCMS 12 transmits the generated integrated running data to the central control system 1.

In an abnormality estimation operation S40, the integrated running data transmitted from the TCMS 12 to the central control system 1 is stored in the server 2, the transmitted integrated running data is analyzed in real time through pretrained AI included in the big data analysis module 200 to diagnose an abnormality in the track or the cars 11, and then a result of estimating an abnormality in the track or the cars 11 is provided to the central control system 1.

In an abnormality handling operation S50, when it is estimated in the abnormality estimation operation S40 that there is an abnormality in the track or the cars 11, the central control system 1 takes measures including slowing down or emergency stopping of the train 10 running on the corresponding track or the train including the corresponding car 11, sending personnel for check and repair work, and the like depending on the type of abnormality or the level of the abnormality, and when the check for an abnormality in the track or the car 11 is completed, an actual measurement result generated from the check is stored in the server 2.

In a retraining operation S60, the estimation result is compared with the actual measurement result, which is generated as a result of checking the track or the car 11, to retrain the AI, and after the retraining is completed, an optimized vibration value tolerance range is transmitted to the vibration diagnosis modules 110 and the big data analysis module 200 to update an existing vibration value tolerance range.

The retraining operation S60 sequentially includes a data selection operation S61 of selecting integrated running data stored in the server 2, a preprocessing operation S62 of preprocessing the selected data, a conversion operation of converting the preprocessed data, a data mining operation S64, and a pattern analysis operation S65.

A process of optimizing the vibration value tolerance range and updating the existing vibration value tolerance range in the vibration diagnosis module 110 and the big data analysis module 200 according to the retraining operation S60 is automatically performed at intervals set by a manager of the system for diagnosing operational safety of railcars, and continuous updates of the vibration value tolerance range improve accuracy of a result of estimating an abnormality in the cars 11 or the track, which leads to a reduction of safety incidents such as derailment of the train 10 and the like.

According to the present invention, sectional units for each track are generated by dividing the entire track on which a train runs into a certain number of sections according to terrain conditions or requirements for safe operation management and maintenance, and vibration data is separately generated for each set track section from vibration signals acquired through vibration sensors. Accordingly, when an abnormality is detected by analyzing the vibration data, it is possible to distinguish between a car abnormality and a track abnormality and specify a location in a track with the abnormality. This leads to rapid countermeasures against abnormal states.

According to the present invention, big data analysis is performed on running data generated from vibration signals which are acquired from cars of trains, and thus it is possible to improve accuracy of an estimation about a car or track abnormality made by a system for diagnosing operational safety of railcars.

According to the present invention, AI for estimating a car or track abnormality is retrained using data which is acquired by performing big data analysis on running data, and a vibration value tolerance range acquired through AI retraining is fed back and periodically updated. Accordingly, it is possible to further improve accuracy of a diagnosis of operational safety of railcars.

Although exemplary embodiments of the present invention have been described above, those of ordinary skill in the art to which the present invention pertains will appreciate that the present invention may be implemented in other specific forms without departing from the technical spirit or essential features thereof.

Therefore, the foregoing embodiments are to be construed as illustrative rather than restrictive in all aspects. The scope of the present invention described in the above detailed description is shown in the following claims, and all modifications or variations derived from the meaning and scope of the claims and the equivalent concepts thereof fall within the scope of the present invention.

What is claimed is:

1. A system for diagnosing operational safety of railcars, the system comprising:
a vibration diagnosis module (110) configured to acquire a vibration signal by measuring vibrations generated from a running car (11) through one or more vibration sensors (101) installed in each car (11) of a train (10) and generate vibration data by analyzing the vibration signal;
a car computer (100) installed in each car (11) and configured to receive the vibration data generated by the vibration diagnosis module (111) of the corresponding car (11) and then generate running data by adding running information including a travel location and a travel speed of the car (11) to the vibration data;
a train control and monitoring system (TCMS) (12) configured to generate integrated running data by aggregating the running data received from the car computers (100) of the cars (11) constituting the train (10) and then transmit the integrated running data to a central control system (1);
a server (2) configured to build big data by storing the integrated running data transmitted to the central control system (1); and
a big data analysis module (200) configured to estimate an abnormal part of a car or a track by analyzing the integrated running data through pretrained artificial intelligence (AI) and transmit the estimated abnormal part to the central control system (1) such that the AI is retrained using data which is acquired by comparing an estimation result with an actual measurement result of an abnormality check,
wherein the entire track on which the train (10) runs is divided into a certain number of sections, and the vibration data measured from the car (11) is generated section by section such that the big data analysis module (200) estimates an abnormal part of a specific car (11) or the track.

2. The system of claim 1, wherein the vibration diagnosis module (110) generates the vibration data using an analysis method based on any one of a root mean square (RMS), a vibration level, a ride comfort index, and a ride comfort level which are representative values of a dynamic state of the car (11).

3. The system of claim 1, wherein the vibration sensors (111) of the vibration diagnosis module (110) are installed on a main part of the car (11) including a wheelset or a bogie.

4. The system of claim 1, wherein the vibration diagnosis module (110) determines whether the generated vibration data falls within a preset vibration value tolerance range for a corresponding track section, transmits a determination result to the car computer (100) along with the vibration data, and feeds an AI retraining result based on big data analysis by the big data analysis module (200) back to continuously update the preset vibration value tolerance range.

5. The system of claim 4, wherein the preset vibration value tolerance range is set depending on types including a vehicle type of the train (10) or cars (11), a format of the train (10) or the cars (11), or the number of organized cars (11), and
the integrated running data transmitted from the TCMS (12) to the central control system (1) includes type-specific data including the vehicle type of the train (10) or the cars (11), the format of the train (10) or the cars (11), or the number of organized cars (11).

6. The system of claim 1, wherein the big data analysis module (200) builds an abnormality diagnosis map of the track and the cars (11) by diagnosing a specific track section as a dangerous section when abnormal vibration data is measured from a plurality of trains running on the track section, or diagnosing a specific car (11) with an abnormality when abnormal vibration data is measured from the car (11) running on all track sections, and estimates an abnormal part of the track or the car (11).

7. The system of claim 1, wherein the big data analysis module (200) retrains the AI in order of an operation of selecting integrated running data stored in the server (2), an operation of preprocessing the selected data, an operation of converting the preprocessed data, a data mining operation, and a pattern analysis operation.

8. The system of claim 7, wherein the pattern analysis operation is performed using any one selected from among linear regression, an artificial neural network, K-nearest neighbor, and unsupervised learning.

9. A method of diagnosing operational safety of railcars, the method comprising:
a vibration data generation operation (S10) in which a vibration diagnosis module (110) receiving a measurement signal from one or more vibration sensors (111) installed in each car (11) of a train (10) acquires a vibration signal by measuring vibrations generated from the running car (11) and generates vibration data by analyzing the vibration signal;
a running data generation operation (S20) in which a car computer (100) installed in the car (11) receives the vibration data generated by the vibration diagnosis module (110) of the car (11) and generates running data by adding running information including a travel location and a travel speed of the car (11) to the vibration data;
an integrated running data generation operation (S30) in which a train control and monitoring system (TCMS) generates integrated running data by aggregating the running data received from the car computers (100) of the cars (11) constituting the train (10) and then transmits the integrated running data to a central control system;
an abnormality estimation operation (S40) of storing the integrated running data transmitted to the central control system (1) in a server, analyzing the transmitted integrated running data through pretrained artificial intelligence (AI) included in a big data analysis module (200), wherein the analyzing of the integrated running data comprises dividing an entire track on which the train (10) runs into a certain number of sections, separately generating vibration data measured from the car (11) section by section, diagnosing a specific track section as a dangerous section when abnormal vibration data is measured from a plurality of trains (10) running on the track section, or diagnosing a specific car (11) with an abnormality when abnormal vibration data is measured from the car (11) running on all track sections, and providing a result of estimating an abnormality in the track or the car (11) to the central control system;
an abnormality handling operation (S50) in which the central control system (1) takes measures against an abnormal situation when an abnormality in the track or the car (11) is estimated; and
a retraining operation (S60) of comparing the estimation result with an actual measurement result of an abnormality check to retrain the AI.

10. The method of claim 9, wherein the vibration data generation operation (S10) comprises determining, by the vibration diagnosis module (200), whether the measured vibration data falls within a preset vibration value tolerance range for a corresponding track section and transmitting a determination result to the car computer (100) along with the vibration data, and
the retraining operation (S60) comprises feeding an AI retraining result based on big data analysis by the big data analysis module (200) back to the vibration diagnosis module (110) to continuously update the preset vibration value tolerance range.

11. The method of claim 9, wherein the retraining operation (S60) comprises retraining, by the big data analysis module (200), the AI in order of an operation of selecting integrated running data stored in the server (2) (S61), an operation of preprocessing the selected data (S62), an operation of converting the preprocessed data (S63), a data mining operation (S64), and a pattern analysis operation (S65), and
the pattern analysis operation (S65) is performed using any one selected from among linear regression, an artificial neural network, K-nearest neighbor, and unsupervised learning.
